(19) United States
(12) Patent Application Publication
(10) Pub. No.: US 2014/0136430 A1
(43) Pub. Date: May 15, 2014

(54) PRODUCT INTEGRITY MONITOR

(71) Applicant: Gary Pope, Agoura Hills, CA (US)

(72) Inventor: Gary Pope, Agoura Hills, CA (US)

(21) Appl. No.: 14/081,420

(22) Filed: Nov. 15, 2013

Related U.S. Application Data
(60) Provisional application No. 61/727,041, filed on Nov. 15, 2012.

(51) Int. Cl. G06Q 30/00

(52) U.S. Cl. CPC G06Q 30/018
USPC 705/317

(57) ABSTRACT

A small electronic, device system comprising a product integrity monitor; a reader; a processor; and a database, wherein the product integrity monitor senses an environment condition and stores or communicates the condition to the processor and database through the reader and is analyzed by the processor. The system may also comprise a remote control operable to store, communicate, and process the data.

### CROSS-REFERENCE TO RELATED APPLICATION

This patent application claims the benefit of U.S. Provisional Patent Application Ser. No. 611727,041, entitled “PRODUCT INTEGRITY MONITOR” filed Nov. 15. 2012, which application is incorporated in its entirety here by this reference,

### TECHNICAL FIELD

This invention relates to small electronic devices that monitor the condition of perishable products as they move through harvest, production, shipping, and sales.

### BACKGROUND

In general, stores carry numerous perishable products. Stores need to make sure their products are in an acceptable condition to be sold. To ensure a product's quality, it is important for a store to track the conditions of its products throughout harvest, production, shipping and sales. For example, the most important factor in the spoilage of perishables is temperature. If a store tracks the temperature of a product, it can predict the shelf-life of each product and will know when to remove spoiled products and order new products.

Recently there has been a move in stores to use sensors on products, such as food and medication, that detect temperature and communicate wirelessly through radio frequency transmitters. However, those devices have limited storage space and typically do not provide comprehensive analysis of different products over different variables.

Thus, there is a need for small electronic devices that smartly store their data and can track different conditions and respond to smart instructions that are easily customizable through software and hardware.

### SUMMARY

The present invention is directed to a small electronic device system designed for collecting and analyzing data through configurable hardware and software. The small electronic device system may comprise a product integrity monitor; a reader; a processor; and a database. The product integrity monitor senses an environment condition and stores or communicates the condition to the processor and database through the reader and is analyzed by the processor. The system may also comprise a remote control operable to store, communicate, and process the data.

Thus, the processor can send commands to the product integrity monitor, send data to the database, provide warnings to a user, and generate reports on a product.

### BRIEF DESCRIPTION OF DRAWINGS

FIG. 1 shows a diagram of one embodiment of the electronic device system;

FIG. 2 shows one embodiment of the product integrity monitor;

FIG. 3 shows one embodiment of the reader;

FIG. 4 shows one embodiment of the remote control;

FIG. 5 shows one embodiment of a graphical user interface on a control computer;

FIG. 6 shows a sample histogram of collected environment data;

FIG. 7 shows a sample history of environment data for a product integrity monitor

FIG. 8 shows a sample compressed history of environment data for as product integrity monitor; and

FIG. 9 shows a sample product integrity monitor summary report.

### DETAILED DESCRIPTION OF THE INVENTION

The detailed description set forth below in connection with the appended drawings is intended as a description of presently-preferred embodiments of the invention and is not intended to represent the only forms in which the present invention may be constructed or utilized. The description sets forth the functions and the sequence of steps for constructing and operating the e invention in connection with the illustrated embodiments. It is to be understood, however, that the same or equivalent functions and sequences may be accomplished by different embodiments that are also intended to be encompassed within the spirit and scope of the invention.

The product integrity monitor system 100 uses a plurality of product integrity monitors (“PIM”) 110 to sense the environment of perishable products so that a product integrity (remaining shelf life) of the products may be determined. By way of example only the PIM 110 may monitor the temperature of packaged food or its surrounding environment as it is transported to a store, where the remaining shelf life is calculated from the data stored in the PIM 110. This helps ensure that a store maintains unspoiled products for sale to customers. In some embodiments, each worker along the product line would have is remote control 130 with the worker's identifying information, such as a remote control ID. As the products were passed into is worker's care, such as a driver who is transporting goods via a truck, the worker may log the identifying information into the PIM 110 using the remote control 130. This allows a user viewing a history of temperature logs to know the stage of delivery and the location of the products, which provides a better understanding of the environment conditions of the products.

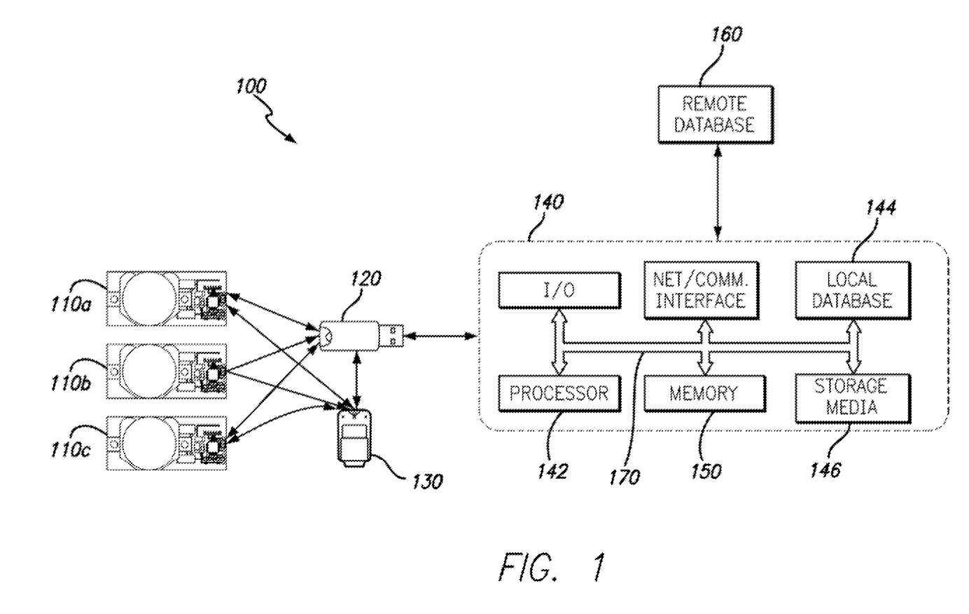

In the embodiment in FIG. 1, the PIMs 110a-c store the environment data in their memory 220. A control computer 140 can execute instructions, such as requesting the data saved on the PIM 110, by using a reader 120 to communicate wirelessly with each PIM 110. in the alternative, the computer system 140 communicates with the remote control 130 wirelessly via the reader 120 and gives it a set of instructions to execute. By way of example only, the instruction set may comprise collecting environment data logs from each PIM 110, calculating the product integrity, and logging in the remote control ID into the PIM 110. A user utilizing the remote control 130 would then execute the instruction set for multiple PIMs 110 and eventually communicate the environment data wirelessly to a control computer 140 via the reader 120. The control computer 140 saves the environment data in its local database 144. The local database 144 keeps environment data logs and information on how to calculate the product integrity of each product. Although FIG. 1 shows the local database 144 and storage media 146 as separate units in the control computer 140, in some embodiments the local database 144 is part of the storage media 146, and in some embodiments the local database 144 is not part of the control computer 140, but is connected through a network connection. The control computer 140 calculates the product integrity of various products based on environment data and algorithms that determine how fast product integrity deteriorates in different conditions for the various products. This environment data and algorithms may be communicated back and forth between the local database 144 and a remote database 160 to ensure that the electronic device system 100 is always up to date.

The PIM 110 is a small electronic device to monitor the condition of perishable products as they move through harvest, production, shipping, and sales on their way to consumers. One function is to provide an estimate of how much shelf life is left in the product and to do so “on-the-fly” so that handling decisions can be made in real-time. Unlike other devices, the shelf-life is not computed by the PIM 110. Instead, the PIM 110 uses a sensor 210 to measure the temperature (or other environment data) and stores the temperature data (or environment data) in the memory 220 in such a way that the control computer 140 can quickly retrieve the necessary data and perform the computation via the computer processor 142. One PIM 110 can monitor several different products if they are all in the same environment. The PIM 110 can provide tracking of batches, shipping routes, inspections, and other data and can he used to validate the origin and authenticity of a product, as each PIM 110 has a unique identifier.

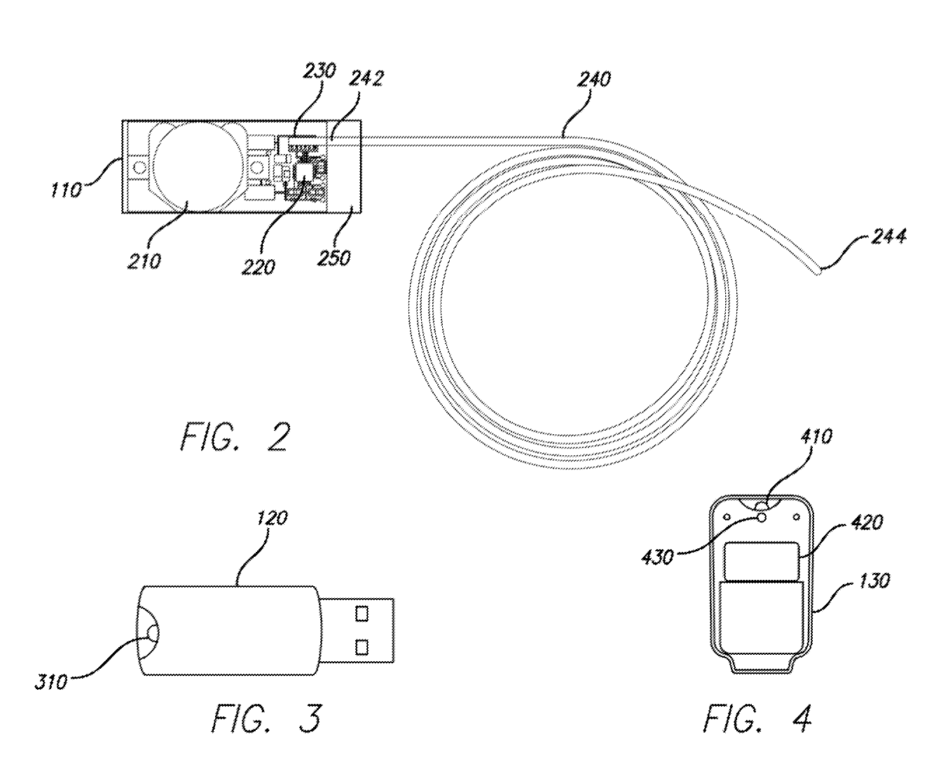

PIMs 110 can be packaged in different forms to match the product. For example, one embodiment of the PIM 110 is a flat 20 mm×50 mm tag that can be attached to a tray, box, or palette. Another embodiment of the PIM 110 is small enough to be packaged to fit on a child-proof top of a medicine bottle. In some embodiments, there may be additions to the PIM 110 or product packaging to increase the range the PIM 110 is able to communicate wirelessly. For example, a PIM 114 using infrared signaling may have a range of several feet through air and only several inches through thick white Styrofoam. In some embodiments, at light pipe 240 may be attached to the PIM transponder 230 at a first end 242 of the light pipe 240 as shown in FIG. 2. This would allow a PIM 110 located inside the packaging of a product to route the light pipe 240 outside the packaging such that the infrared signal could be read from a second end 244 of the light pipe 240 instead of through the packaging. The light pipe 240 may he any kind of signal carrying cable or tubing, such as flexible, vinyl tubing for infrared signals. A protective sheath 250 may be used to cover the PIM 110 from moisture, debris, and other elements that could damage the PIM 110. The protective sheath 250 may be water proof, such as plastic, vinyl, and the like.

In some embodiments, the PIM 110 monitors the most important factor in the spoilage of perishable goods, i.e. temperature. In some embodiments, the PIM 110 monitors other conditions such as humidity, vibration, and any other condition that could affect the spoilage of perishable goods. In some embodiments, the PIM 110 may measure ambient temperature, calculate the internal temperature of a product based on the ambient temperature and save the calculated internal temperature in its memory to more accurately determine product integrity. In some embodiments, the PIM 110 also monitors battery life.

In some embodiments, the PIM 110 can have multiple states of operation. By way of example only, the PIM 110 can have an enabled state, a disabled state, a delayed state, and a reset state. These states may determine, among other things, whether the PIM 110 is collecting data, how it is collecting data, and what data is saved.

In some embodiments, the PIM 110 communicates with a reader 120 and/or a remote control 130 wirelessly using infrared signaling, much like a TV remote control. The communication can be read through glass, translucent plastic, or water. In some embodiments, PIMs 110 communicate using near field communication (NFC), radio frequency identification (RFID), or Bluetooth communication. In some embodiments, this communication has security features so the system can only be accessed by authorized users.

The reader 120 is a device that allows a computer 140 to communicate with other devices wirelessly. In some embodiments, the reader 120 is a small USB device that plugs into a computer 140 and provides wireless communication between the computer 140 and the PIM 110, or provides wireless communication between the computer 140 and the remote control 130, as shown in FIG. 1A. driver may be installed on the control computer 140 to allow the control computer to utilize the reader 120. An example of a reader 120 with a transceiver 310 is shown in FIG. 3.

As shown in FIG. 4, the remote control 130 may be an inexpensive, hand-held device for interacting with the PIM 110 wirelessly. In some embodiments, the remote control 130 communicates with the PIM 110 and reader 120 through infrared communication using a transceiver 410, as shown in FIGS. 1 and 4. The control computer 140 can save a set of instructions, called a mission, in the remote control 130, wherein the mission may automatically execute or be manually executed by the user through the remote control's controls. These missions are detailed later in discussing the control computer software. Any environment data received during the mission is saved in the remote control 130 for later transfer to the control computer 140 and local database 144.

In some embodiments, the remote control 130 also comprises an execute button 420 and at least one indicator 430, as shown in FIG. 4. Pressing and holding an execute button 420 causes the remote control 130 to start searching for PIMs 110. The indicator 430 may indicate the remote control's current status, such as if the remote control is searching for PIMs 110. When pointed at a PIM 110, the remote control 130 turns off the indicator 430 and executes its mission. When the mission is complete, the indicator 430 notifies the user of the status of the execution. The indicator 430 may be visual, auditory, or tactile. For example, the indicator 430 may display green for success, yellow for warning, or red for failure depending on the mission. In some embodiments, there may be separate indicators 430 for different signals. In some embodiments, the remote control 130 may include a display to indicate the status of a mission or a calculated value.

If the execute button 420 is still pressed (or locked on an active mode), the remote control 130 resumes its search for other PIMs 110. Any given PIM 110 will only be acted on once while the execute button 420 is pressed. A reset option may be used to reset the remote control 130 so that it can act on a PIM 110 that was previously acted upon in case a second or subsequent read is desired. In some embodiments, a user can choose from a plurality of missions saved in the remote control to execute different missions for different PIMs. In some embodiments, the mission executed depends on a sequence of button presses of the remote control 130.

As shown in FIG. 1, rather than have the remote control 130 execute missions, the control computer 140 may also execute missions and communicate with the PIMs 110 through a reader 120. A control processor 142 in the control computer 140 executes a PIM software saved in the control computer's non-transitory media 146 to set up, execute, and process missions.

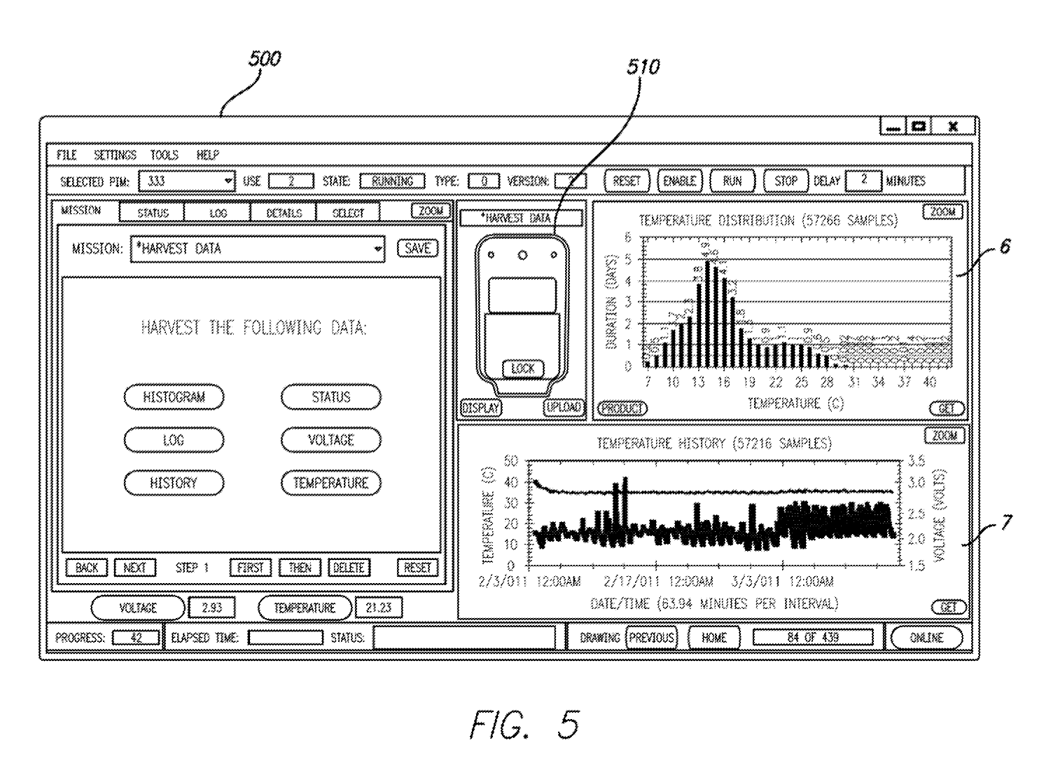

A Graphical User Interface (GUI) 500, as shown in FIG. 5, is used to manage missions and view data saved in the database, in this embodiment of the GUI 500, the computer 140 displays an image representing a virtual remote control 510 in the middle of its window. This may represent to the user that missions executable by the remote control 130 are also executable by the control computer 140. In some embodiments, some missions may be exclusive to the control computer 140 or exclusive to the remote control 130.

Missions are selected and/or created using the PIM software. Missions can be shared globally, company-wide, or kept locally. By way of example only, some useful missions may include instructions to calibrate the PIM 110, change settings in the PIM 110, change the state of the PIM 110, check alarms, check the voltage of the battery, calculate a product integrity, harvest data, log data, check a condition to determine the next instruction set to take, calculate a date to remove a product due to low product integrity, generate a report, and send email notifications.

Some missions may be sequential, while others may be branching. Some missions may include instructions that test data from the PIM 110 and conditionally execute a new sequence of instructions before resuming the original sequence of instructions. By way of example only, a mission may include an instruction to check to see if as battery level in a PIM 110 is low. If it is, the mission will execute an instruction to email an alert to a user to inform the user to replace the battery. After that instruction is executed, the mission will resume its normal sequence of instructions.

At any point, an instruction may terminate a mission and notify the user of the status of the execution. By way of example only, an indicator 430 on a remote control 130 may display green for success. yellow for warning, or red for failure depending on the mission. The GUI 500 should enable a user to organize missions for the control computer 140 or the remote control 130 to execute.

Local users may create their own missions by making an ordered list of instructions. The customized missions may take into account specific products or conditions that may affect communications and calculations. For example, in a configuration where there are multiple readers and multiple PIMs where coverage may overlap, the user can use features on the PIM software to prevent copies of data entries in the database. If different missions are customized with the same name but come from different sources, they may display a suffix of (G), (C), or (L) to indicate whether the missions came from the Global, Company, or Local databases respectively.

Every instruction in a mission can potentially generate an event. An event is the unit of information that is stored in the company database. In some embodiments, each event includes a field, such as an XML string, defining the hill details of what information was written to or read from the PIM 110. It may also include the date/time of the event, the identification of the PIM 110, and other information that might be useful when searching or filtering the database.

The PIM software can control what events and what type of information are reported to the database. The PIM software can allow a user to browse, search, and filter the database to create reports.

The processor 142 can calculate the integrity (e.g. the remaining shelf-life) of a product, based on sensor input from the PIM 110 and an algorithm. The integrity starts at 100% and declines to 0% when the product is no longer viable. A current instruction in the PIM software can compute the integrity fur a specified product type. The processor can also display the integrity in graphs such as a histogram 6 as shown in FIG. 5.

One method of computing the product integrity is by using, life curve data that models the degradation of specific products. For most products, the life curve is an exponential function known as the Arrhenius curve. A global database provides the life curves of many products and provides access to that information to the company and local databases. Some products may not be in the global database and may need to be calculated based on collected data. Some specific examples of ways the PIM software can calculate life curves include entering in the known shelf lives of products at varying temperatures, entering in a Q10 value, and/or entering activation energy of a product. The calculated life curve can be displayed in the GUI 500 and assigned to a product. This can then be uploaded to the company database to be used company-wide.

By way of example only, the computer processor 142 may calculate a product integrity of a product by measuring how long a product was at certain temperatures. The life curve models the deterioration rate of the product at different temperatures to determine how much product integrity remains. Because product integrity is determined by the amount of time spent at each temperature and not necessarily the order in which the temperature occurred, a histogram 6 is an ideal storage solution. It allows for quicker calculation of product integrity, while using a very small amount of memory.

By way of example only, histograms 6 keep track of temperature data by counting how many reading made by the PIM 110 occurred for any given temperature. Temperatures are partitioned into “bins” representing ranges of temperature. Each time the PIM store temperature data, a matching bin is found and its count is incrementally increased. When displayed graphically, histograms 6 appear as a bar chart as shown in FIG. 6. When viewed in the GUI 500, histograms 6 may also display the product integrity.

By way of example only, some embodiments of the histogram 6 may have a default of 100 bins, each representing 1 degree Celsius. This gives the histogram a 1 degree resolution through the entire temperature range supported by the PIM (−30° C. to 70° C.). That resolution should be adequate for almost any application. The number of bins, temperature increments, time of reading, and the like can be custom set by the user. In some embodiments, an interface may support changing the mapping of temperatures-to-bins.

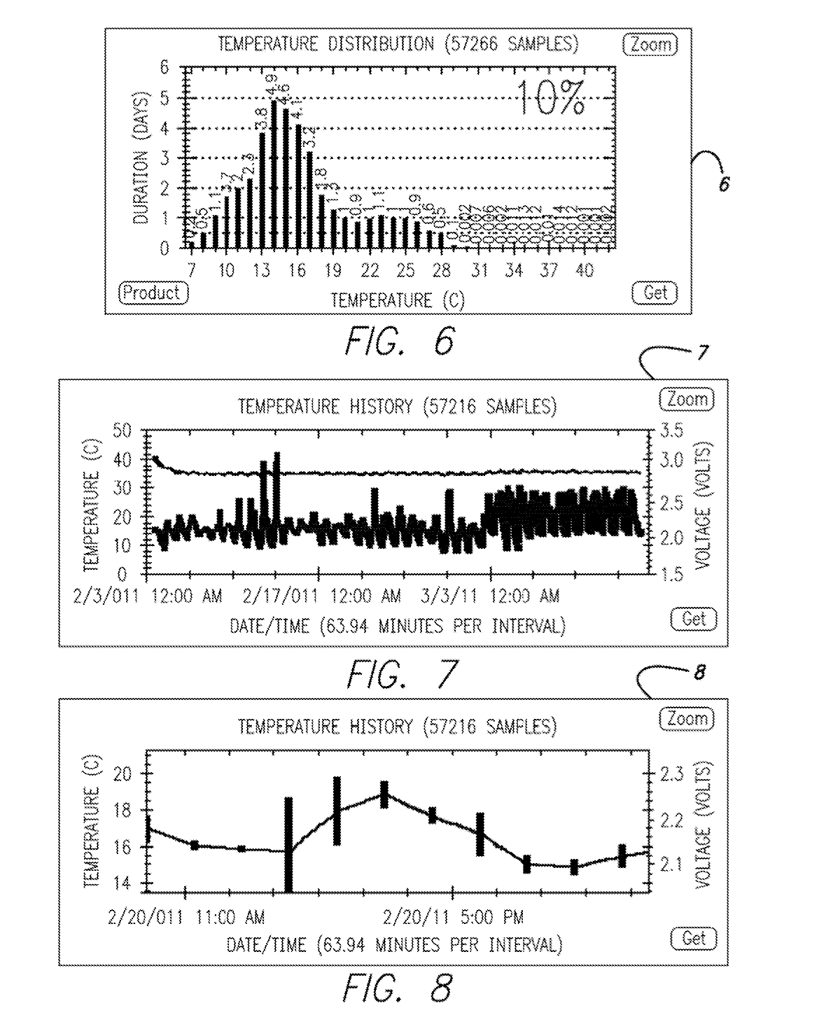

The history 7 keeps track of temperature and other sensor samples by logging each sample as it is taken. This results in a time-ordered record of the samples. This can be useful in matching the tracked information with other occurrences. For example, it can show who had custody of the product when a particular temperature excursion occurred. When displayed graphically, the history 7 appears as a line chart as shown in FIG. 7.

A problem with traditional data loggers is that they have a limited amount of memory available to store samples. To avoid running out of memory, the sample rate has to be adjusted to match the expected length of time that the product will be monitored. This can result in a sample rate that is too slow to catch important temperature events.

The PIM 110 may solve this problem by compressing the history 7 as needed. This can be done by several methods. As shown in FIG. 8 a compressed history may increase the she of its interval and reduce the amount of data to be saved. By way of example only, a history storing one sample per minute (sampling rate) for one hour would save 1 data point per 1 minute interval (reporting interval) for a total of 60 data points. If the data was compressed by increasing the reporting interval to 10 Minutes and only saved the maximum and minimum values of each interval, the history would store only 12 data points. Even if the sampling rate stayed at one sample per minute, the saved compressed history would still only have 2 data points per reporting interval. The inclusion of the minimum and maximum data points prevents the loss of any significant data events.

By way of example only, a PIM 110 with the capacity to store 8192 sensor samples and a sampling rate of 1 sensor sample every 60 seconds (reporting interval =1 minute) will be able to save every sample tor approximately 5.6 days. When the capacity reaches a predetermined value, the history will be compressed by increasing the reporting interval (for example: 4 minutes) and only saving two samples per interval (the min and the max values of the environment data along that interval). The reporting interval can be increased as many times as needed. When the reporting interval is increased to 4 minutes, the history may include data for approximately 11.3 days. The history 7 will be compressed only as needed to ensure the highest quality of data possible. This technique allows as history 7 to he maintained for the full time the PIM 110 runs without ever missing a significant temperature excursion. The actual sample rate (1 sample every 60 seconds) never changes, just the reporting interval. FIG. 8 shows a graphical representation of the history of compressed temperature readings wherein the interval has been increased to approximately 64 minutes per interval, showing the max and min of each interval.

In some embodiments, the PIN 110 has a section of memory for user-supplied data called a log. The purpose of the log is to keep track of significant events that may correlate with the temperature tor other sensor) data in the history, such as product inspections and custody changes (e.g. Grower-to-Shipper). The data in the log can be identifying information about the product being monitored such as its name, batch number, and production date. It can also be data about events that have occurred during monitoring, like who inspected the product, who had custody, and which route the product took to its destination. The data can be used to produce reports at the end of a trip, or to make decisions on-the-fly while the product is still in the supply chain.

To add information to the log, you can specify what type of item you are logging and its value. For example, you could log a “ProductName” item with a value of “PIM 1”. The item is added to the log and time-stamped with the current time. You can add additional “ProductName ” items if you are monitoring a shipment of several different products. In some embodiments, you can create new item types using an item editor tool.

In some embodiments, the PIM software uses a three-tiered database model to manage users' access to data. An example of three tiers would he a global database, company database, and local database 144. The global database and company database may be remote databases 16 that are not located at the site of the local database 144.

The global database would be a public database, managed by a central agency that all PIM 110 users are automatically connected to. Its primary purpose is to provide as much commonality as possible in the data being stored into and retrieved from PIMs 110. This is important to avoid conflicts in data interpretation as PIMs 110 move through the hands of suppliers, shippers, warehouses, retailers, and end users. Examples of data that must be global are PIM IDs, log item IDs, and data types. The global database provides for the central allocation of PIM ID numbers so that there are never two PIMs 110 with the same PIM ID. Log item IDs are stored as numbers rather than names to conserve space in the log. These item IDs must be globally unique to insure that data entered by one user will not appear as something completely different to the next user. Data types must be associated between log items IDs. Each log item has an associated data type. For example, the log item “Brand Owner” has a type of “String”. The global database and an item editor tool would ensure that the log item and data type would be unique globally.

A purpose of a global database is to provide a central point for the distribution of instructions, reports, etc. This will allow companies to provide their customers with data in order to give a head start in developing their own applications. The global database may have the most updated firmware that companies can download to their company database and local database 144.

The company database is intended to be accessible only to members of a specific community or company. Its primary purpose is to host an events list of all events gathered and reported by the PIM software. Its secondary purpose is to provide common storage of data, instructions, etc. that only need to be known or used within the company. Companies can customize missions or sets of instructions in their company database to be tailored to their products and needs.

The local database 144 may be part of the control computer 140 running the PIM software or it may be connected to the control computer 140 through a local network connection. In the preferred embodiment, the local database 144 may be primarily used to store data that may be “works-in-progress”, i.e. not ready for companywide or global release. A user of a local database 144 may need to validate data in the local database 144 before uploading it to the company or global database. The local database 144 may also store copies of relevant portions of the global and company databases for faster access.

In some embodiments, in order to see the global and company databases, the PIM software must be online. There will be cases, however, when it is not practical to be online. In these cases, the PIM software reverts to using local copies of the global and company databases. Certain functions, such as assigning PIM IDs and creating new log items, are disabled. But most functionality is still available in the offline mode. Most importantly, data can still be harvested from PIMs 110 and reported to the local version of the company database. That data can then be uploaded to the real company database when the PIM software is put back online.

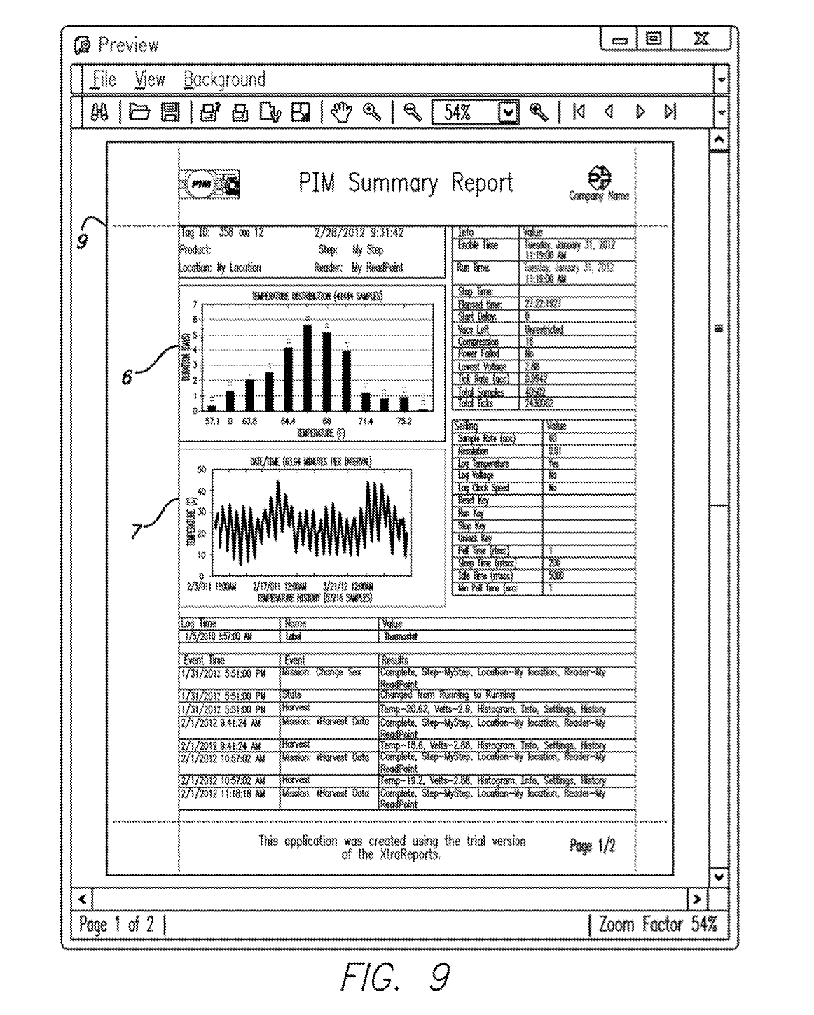

In some embodiments, the processor 142 can generate reports that automatically extract, organize, and summarize event data as shown in FIG. 9. These reports can analyze events, make comparisons, detect patterns and relationships, and discover trends. These reports would allow users to quickly and easily summarize and analyze large numbers of events by dragging and dropping columns to different rows, columns, or summary positions. In some embodiments, the user could filter events before generating a report to avoid the download of unwanted events from a database.

In some embodiments, a user may wish to create custom fields in the local database 144 or PIM 110. Events often have a lot of data associated with them and the data varies greatly between events. For example, in order to accommodate this in the database, each row in an event table contains a field that holds an XML string containing all of the event's data. Other fields contain data that has been extracted from the XML and “promoted” to their own fields. These additional fields make searching for and filtering of events much more efficient. The problem if everything is promoted is there would be tar too many fields for the database to handle. This problem is especially apparent when considering all of the possible item types that can appear in a PIM's log.

The PIM software may solve this problem by automatically promoting a standard set of fields and providing a mechanism that lets users (usually the user maintaining the company database) define their own additional fields as needed. In some embodiments, these field definitions involve naming the new field, specifying its type, and describing how to extract the corresponding data from the XML. These definitions are then saved on the company database. When the PIM software starts-up, it reads these definitions and when it reports a new event to the database, does the specified extractions.

These new fields can be added to the actual database or can be extracted only as needed to generate reports.

In one embodiment, extracting fields can be done using a standard processing language called XPATH. For example, an xProduct field is added to the database as a String valued field. It is extracted from Harvest events by searching for a log entry with the name “ProductName”.

The PIM software can take the form of a computer program product accessible from a non-transitory computer-usable or computer-readable medium providing program code for use by or in connection with a computer or data processing system. For the purposes of this description, a computer-usable or computer readable medium can be any apparatus that can contain, store, communicate, propagate, or transport the program for use by or in connection with the instruction execution system, apparatus, or device.

The medium can be an apparatus or device that utilizes or implements electronic, magnetic, optical, electromagnetic, infrared signal or other propagation medium, or semiconductor system. Examples of a computer-readable medium comprise a semiconductor or solid-state memory, magnetic tape, a removable computer diskette, a random access memory (RAM), a read-only memory (ROM), a rigid magnetic disk and an optical disk. Examples of a computer-readable medium in FIG. 1 include the memory unit 150, storage media 146, local database 144, and remote database 160.

A data processing system suitable tor storing and/or executing program code comprises at least one processor coupled directly or indirectly to memory elements through a system bus 170. The memory elements can include local memory employed during actual execution of the program code, bulk storage, and cache memories that provide temporary storage of at least sonic program code in order to reduce the number of times code is retrieved from bulk storage during execution.

Input/output or I/O devices (including but not limited to keyboards, displays, pointing devices, etc.) can be coupled to the processing system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention not be limited by this detailed description, but by the claims and the equivalents to the claims appended hereto.

What is claimed is:

1. An electronic device system for monitoring a product integrity of one or more perishable products, comprising:
a. one or more product integrity monitors, each comprising:
i. a sensor for measuring temperature,
ii. a product integrity monitor memory associated for storing temperature data logs, wherein the product integrity monitor memory automatically compresses the temperature data logs when the product integrity monitor memory reaches a predetermined value, and
iii. an infrared transponder for receiving requests and transmitting temperature data logs;
b. one or more databases for storing temperature data logs and instructions;
c. a control computer operably connected to the one or more databases, the control computer comprising:
i. one or more control processors,
ii. a control non-transitory computer-readable medium storing instructions executable by the one or more control processors to perform operations for obtaining the temperature data logs and calculating product integrity, the operations comprising:
requesting and receiving the temperature data logs,
storing the temperature data logs in the one or more databases, and
analyzing the temperature data logs to determine the product integrity of the One or more perishable products;
d. one or more readers operably connected to the control computer, each reader comprising: an infrared reader transceiver operable to transmit and receive data via infrared communication; and
e. one or more remote controls operable to communicate with the control computer via the one or more readers and is operable to communicate with the one or more product integrity monitors, each remote control comprising:
i. one or more remote control processors,
ii. an infrared remote control transceiver,
iii. a remote control non-transitory computer-readable medium storing remote control instructions executable by the one or more remote control processors to perform operations remotely from the control computer, the operations comprising;
receiving and storing a set of instructions from the control computer via the one or more readers,
detecting the one or more product integrity monitors in range of the one or more remote controls, and
executing the set of instructions via the remote control processors, wherein the set of instructions comprises requesting and receiving temperature data logs from the one or more product integrity monitors, storing the temperature data logs, and transmitting the temperature data logs to the control computer via the one or more readers,

2. The electronic device system of claim 1, wherein the control computer is operable to send alerts if a product integrity falls below a threshold value.

3. An electronic device system for monitoring a product integrity for one or more goods, comprising:
a. one or more product integrity monitors, each comprising:
i. a sensor for measuring environment data,
ii. a product integrity monitor memory for storing environment data logs, wherein the environment data logs are associated with one or more goods, and
iii. a transponder operable to receive requests and transmit the environment data logs via wireless communication;
b. one or more databases for storing and transmitting information;
c. a control computer operably connected to the one or more databases, the control computer comprising:
i. one or more control processors,
ii. a control non-transitory computer-readable medium storing instructions executable by the one or more control processors to perform operations for obtaining environment data logs and calculating product integrity, the operations comprising:
requesting and receiving the environment data environment data logs,
storing the environment data logs in the one or more databases, and
analyzing the environment data logs to determine the product integrity of the one or more goods; and
d. one or more readers operably connected to the control computer, each reader comprising; a reader transceiver operable to transmit and receive data via wireless communication,
i. wherein the one or more readers are operable to request and receive the environment data logs from the product integrity monitors, and
ii. wherein the one or more readers are operable to transfer the environment data logs to the control computer.

4. The electronic device system of claim 3, further comprising: one or more remote controls operable to communicate with the control computer via wireless communication with the one or more readers and is operable to communicate with the one or more product integrity monitor' via wireless communication, each remote control comprising:
a. one or more remote control processors;
b. a remote control transceiver operable to transmit and receive data via wireless communication; and
c. a remote control non-transitory computer-readable medium storing remote control instructions executable by the one Or more remote control processors to perform operations remotely from the control computer, the Operations comprising:
i. receiving and storing a set of instructions from the control computer via the one or more readers,
ii. detecting the one or more product integrity monitors in range of the one or more remote controls,
iii. executing the set of instructions via the remote control processors, wherein the set of instructions comprises requesting and receiving environment data logs from the one or molt product integrity monitors, storing the environment data logs, and transmitting the environment data logs to the control computer via the one or more readers.

5. The electronic device system of claim 4, wherein the one or more databases comprises a local database operably connected to a remote database via a network, wherein the local database is operable to download event logs, environment data logs, and product integrity calculation data.

6. The electronic device system of claim 5, wherein the control computer is operable to download additional executable instructions from the remote database to the control non transitory computer-readable medium

7. The electronic device system of claim 6, wherein the control computer is operable to arrange the additional executable instructions in a listed instruction set, wherein the control computer is operable to send the listed instruction set to the one or more remote controls to be executed by the one or more remote control processors.

8. The electronic device system of claim 7. wherein the listed instruction set comprises a conditional instruction, a first set of instructions, and a second set of instructions; wherein the conditional instruction checks for a condition to determine whether the first set of instructions or the second set of instructions is executed.

9. The electronic device system of claim 4, wherein the wireless communication used by the transponder, the reader transceiver, and the remote control transceiver is infrared communication.

10. The electronic device system of claim 9, wherein the one or more product integrity monitors further comprises a tubing operably connected to the transponder to increase the range of infrared communication.

11. The electronic device system of claim 10, wherein the tubing is a vinyl light pipe.

12. The electronic device system of claim 3, wherein the product integrity monitor memory automatically compresses the environment data logs when the product integrity monitor memory reaches a predetermined value.

13. A method for monitoring a product integrity of one or more perishable goods via an electronic device system, the method comprising:
a. monitoring an environment of the one or more perishable goods via an electronic device comprising a sensor and a non-transitory computer-readable memory;
b. storing environment data in the memory;
c. sharing the environment data with a computer system via a wireless communication device operably connected to the computer system.
d. storing the environment data in a database; and
e. calculating the product integrity of the one or more perishable goods via a computer processor in the computer system, wherein the product integrity is calculated based on the environment data in the database.

14. The method of claim 13, wherein the step of sharing the environment data is performed via infrared communication.

15. The method of claim 14, wherein the step of sharing the environment data comprises:
a. sharing the environment data in the electronic device with a secondary device within infrared communication range of the electronic device; and then
b. sharing the environment data in the secondary device with the wireless communication device, wherein the secondary device is within infrared communication rage of the wireless communication device.

16. The method of claim 15, wherein the environment data stored in the memory is temperature data.

17. The method of claim 16, wherein the environment data stored in the memory is saved as a histogram and a history, wherein the step of storing the environment data further comprises compressing the history by increasing a reporting interval and saving a minimum data value and a maximum data value per reporting interval.

18. The method of claim 16, wherein the step of calculating the product integrity is further based on a mathematical curve in the database that determines a reduction of product integrity based on time at a temperature.

19. The method of claim 16, further comprising after the calculating step: alerting a user if the product integrity of the one or more perishable goods is below a threshold value.

20. The method of claim 16, further comprising: generating a report regarding the product integrity of the one or more perishable goods.
